(19) United States
(12) Patent Application Publication
(10) Pub. No.: US 2011/0315233 A1
(43) Pub. Date: Dec. 29, 2011

(54) Universal Subsea Oil Containment System and Method

(76) Inventor: George Carter, Lucas, TX (US)

(21) Appl. No.: 13/162,666

(22) Filed: Jun. 17, 2011

Related U.S. Application Data
(63) Continuation of application No. 61/358,697, filed on Jun. 25, 2010.

(51) Int. Cl. F15D 1/00

(52) U.S. Cl. 137/14; 137/154

(57) ABSTRACT

A system, method, and apparatus for containing oil and gas leaking from an underwater wellhead or other man-made structure. The apparatus includes a conduit having an upper end and a lower end with an opening. The conduit is sized for the lower end to be positioned over a plume leaking from the man-made structure and the upper end to be substantially near or at the water surface. In addition, a containment tank is located in the upper portion of the interior of the conduit. The apparatus also includes a first tube for pumping liquid located within the containment tank out of the interior of the conduit, thereby creating a pressure differential between a pressure within the interior of the conduit and a pressure outside the conduit to induce an upward flow of fluids within the conduit. The interior pressure of the conduit is lower than the pressure outside the conduit. The apparatus also includes a second tube for releasing gas from the interior of the conduit. The conduit is positioned over the leaking man-made structure and oil and gas flow upward from the leaking man-made structure through the interior of the conduit.

### RELATED APPLICATIONS

This utility application claims the benefit of U.S. Provisional Patent Application Ser. No. 61/358,697 filed Jun. 25, 2010 by George Carter, which is hereby incorporated by reference.

### BACKGROUND OF THE INVENTION

1. Field of the Invention

This invention relates to oil and gas systems. Specifically, and not by way of limitation, the present invention relates to a system and method of containing hydrocarbons, such as oil and gas, from underwater leaks from man-made structures.

2. Description of the Related Art

Recently, oil and gas companies have been initiating deepwater drilling for capturing oil and gas resources. With the high revenues associated with selling these natural resources, these companies have found it economically viable for using deepwater drilling techniques to capture these oil and gas resources. However, with the use of deepwater drilling, there have been several problems. One such problem occurred in 2010 with the Macondo well blowout in the Gulf of Mexico which caused the destruction of the Deepwater Horizon rig, sadly resulting in loss of life, and was the source of the largest offshore oil spill in U.S. history. The United States government's estimate was that 172 million gallons of oil spilled into the ocean in a period of approximately three months. The National Commission on the BP Deepwater Horizon Oil Spill and Offshore Drilling indicated that both the industry and government were unprepared for such a spill and that deepwater operators need to have detailed source control plans to respond to blowouts.

According to a report by the National Academy of Engineering, the rapid development of new technologies for deepwater drilling have surpassed the regulations expected to evaluate and oversee the industry's safety practices. The BP oil spill exposed the roughly thirty-year technology gap that exists in current methods to cleanup and contain an offshore oil spill, particularly in ultra-deepwater.

Currently, when a wellhead leaks oil and gas, there are limited solutions for alleviating or terminating the leak at deep depths of water. The Marine Well Containment Company and Helix Energy Solutions Group have developed leak remediation plans that use equipment that directly contact by capping or connecting to the BOP. These are useable solutions in some scenarios, however, there are blowout scenarios were leaks develop outside the well casing, or leaks develop from the BOP or a damaged connector. Ideas have arisen to “drop” a containment device over the source of the spill, but containment domes have had limited success in shallow water and have never worked in deepwater environments. A dome-like design, with the open end attempting to seal to ocean floor sediment and debris, is inherently flawed. A new approach is needed to match the task of potential spill cleanup with the realities of deepwater and ultra-deepwater drilling.

It would be advantageous to have a universal system and method which can capture and contain oil and gas leaking from leaks originating from man-made structures at deep underwater depths. It is an object of the present invention to provide such a system and method.

### SUMMARY OF THE INVENTION

In one aspect, the present invention is directed to an apparatus for containing oil and gas leaking from an underwater man-made structure. The apparatus includes a conduit having an upper end and a lower end with an opening. The conduit is sized for the lower end to be positioned over a plume leaking from the man-made structure and the upper end to be substantially near or at the water surface. In addition, a containment tank is located at the upper portion of the interior of the conduit. The apparatus also includes a first tube for pumping liquid located within the containment tank out of the interior of the containment tank and conduit, thereby creating a pressure differential between a pressure within the interior of the conduit and a pressure outside the conduit to induce an upward flow of fluids within the conduit. The interior pressure of the conduit is lower than the pressure outside the conduit. The apparatus also includes a second tube for releasing gas from the interior of the conduit. The conduit is positioned over the leaking man-made structure and liquid and gas flow upward from the leaking man-made structure through the interior of the conduit.

In another aspect, the present invention is directed to a method of containing oil and gas leaking from an underwater man-made structure. The method begins by positioning a conduit over a plume leaking from the man-made structure. The conduit has an upper end located at or substantially near the water surface and a lower end having an opening leading to an interior of the conduit. Water and oil contained in the interior of the conduit are pumped out from an upper portion of the conduit to reduce an interior pressure of the conduit below a pressure outside the conduit to induce an upward flow of fluids. Gas is released through a gas release tube coupled to an interior of the conduit.

### BRIEF DESCRIPTION OF THE DRAWINGS

FIG. 1 is a side view of a containment system in one embodiment of the present invention;

FIG. 2 is a flow chart illustrating the steps of containing and capturing oil and gas from a leaking man-made structure according to the teachings of the present invention; and

FIG. 3 is a side view of a heat exchanger for use in the containment system 10 of FIG. 1

### DESCRIPTION OF THE INVENTION

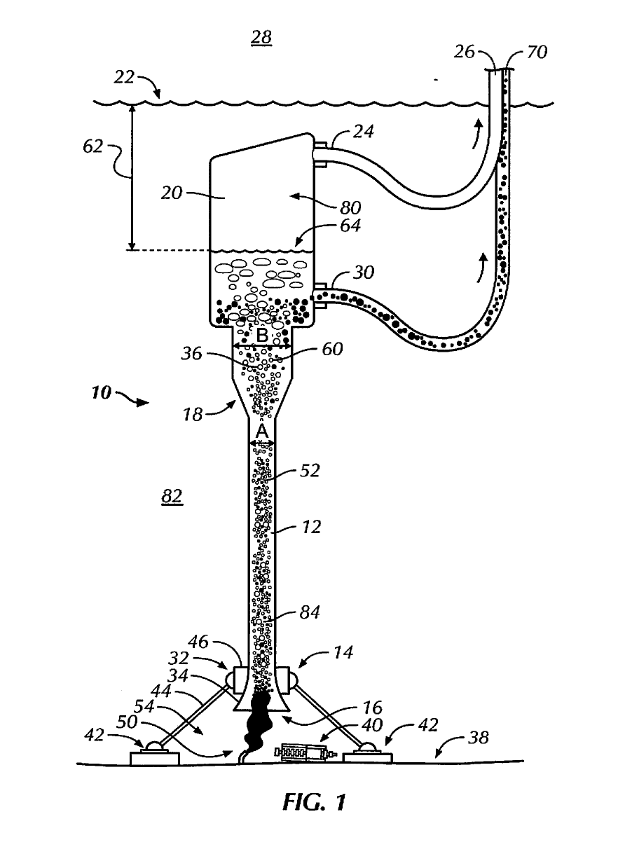

The present invention is a system and method of capturing and containing oil and gas leaking from an underwater man-made structure. FIG. 1 is a side view of a containment system 10 in one embodiment of the present invention. The containment system 10 includes a main conduit 12 having a first lower end 14 with an opening 16 and an opposite second upper end 18 with a containment tank 20. In one embodiment, the containment tank may be located below a water surface 22. In this embodiment, the containment tank may be coupled to a gas release tube 24 leading to the surface 22. The tube 24 may lead to an aperture 26 opened to the outside above-water environment 28 or to a man-made structure such as a ship (not shown). Flow control devices, such as fixed (e.g., Venturi) or variable (e.g., valves) may be used to control the flow of the gas exiting the tube. The containment tank may also include a second liquid ejection tube 30 having a pump (not shown) leading to the surface 22 and a capture vessel or other man-made structure (not shown). In an alternate embodiment, the containment tank may extend above the water surface 22.

In addition, the containment system 10 includes a base section 32 having the lower opening 16 coupled to the lower end 14 of the main conduit. The base section 32 may include an induction bell 34 having a diameter larger than the diameter of the main conduit 12. A dissociation zone 36 may be located in an interior of the conduit where gas-hydrates are dissociated or melted. Gas-hydrates may also form within interior the conduit in a gas-hydrate formation zone 84. The base section may be affixed to a sea floor 38 by any mechanism which allows the containment system to remain stationary over a plume (leak) originating from a man-made structure, such as a damaged blowout prevent (BOP) 40. In one embodiment, the base structure is attached to a plurality of base pylons 42 embedded into the sea floor 38. Preferably, the attachment mechanism includes at least three base pylons having cables 44 affixed to an attachment station 46. The cables may be lengthened or shortened to move the main conduit laterally or vertically in relation to a leak plume 50. In the preferred embodiment of the present invention, the main conduit may include floatation collars (not shown) or other floatation devices to allow the main conduit to float underwater. The cables are used to attach the base structure and main conduit to the pylons. In other embodiments, the present invention may use other attachment devices (e.g., rigid arms) to retain the main conduit underwater and close to the leak. In the preferred embodiment of the present invention, the induction bell is positioned above the plume 50 with a vertical space 54, thereby allowing ambient seawater to flow into an interior 52 of the main conduit. In addition, the open vertical space enables a space around the BOP 40 to be accessed by remote underwater devices such as Remotely Operated Vehicles (ROVs), which may be necessary when operators are attempting to repair the leaking structure while still capturing leaking oil and gas.

The interior 52 of the main conduit 12 may include a multi-phase (slurry) flow zone for oil, gas-hydrates, natural gas, and seawater. The percentage of seawater in the slurry is controlled by adjusting the pressure differential. In the preferred embodiment of the present invention, the main conduit has a diameter A no larger than a standard 21 inch riser. This enables ease in constructing and assembling the containment system utilizing currently used parts and machinery. An upper section 60 of the main conduit may have a large diameter B in comparison to the main conduit to allow expansion from hydrate dissociation (or sublimation), thereby preventing clogging from gas-hydrates. In addition, in other embodiments, there may be many stages of increasingly greater diameters along the span of the conduit.

The conduit may be constructed of any material which may contain a liquid (e.g., liquid-tight). In one embodiment, the conduit may be constructed of a fabric supported by cables running the length of the conduit. Furthermore, the cross-section of the conduit may be any shape. In addition, an interior wall of the conduit may be coated with an epoxy, an epoxy-like material or any other composite material to reduce the adhesive qualities of hydrates to the interior wall. In one embodiment, the conduit is sized in the conduit's length to enable the conduit to be positioned over the plume 50 and still reach near (relative to the depth of the water and length of the conduit) or at the water surface. The conduit may be constructed in sections to accommodate varying depths from the surface to a wellhead. The conduit diameter is large enough to prevent clogging from gas-hydrates and allow for dissociation of hydrates and expansion of natural gas as the gas-hydrates rise toward the surface where the gas is separated from the liquid.

The induction bell 34 may include ports for injecting warm water, anti-agglomerant, or other chemicals into the interior of the conduit. The expanding natural gas and liquid rises up through the conduit into the containment tank 20. A liquid level 64 in the containment tank is adjustable depending on the rate the liquid that is pumped out of the liquid ejection tube 30.

A pump (not shown) may be used to pump out the escaping oil and seawater (liquid) within the containment tank 20 through the liquid ejection tube 30 to a tanker or other storage facility located above water. This liquid may be stored in a tanker (not shown) through an exit point 70. The liquid is pumped out to maintain the liquid level 64 below the water surface 22. This provides a pressure differential 62 between the interior of the conduit and outside water pressure which induces an upward flow of fluids (i.e., seawater, oil, and gas). Specifically, by pumping out the liquid, the liquid level 64 inside the conduit, in the containment tank, is maintained below the water surface, thereby keeping pressure in an interior 80 lower than outside 82 (underwater) at any given depth of the conduit. It should be understood that a conduit may be any device having a passageway or channel which can contain, funnel or channel the escaping gas and oil from the wellhead to the surface. Although the term conduit is used, the present invention is not limited to tubular or pipe-like devices and may be configured in any size and shape. In addition, the tubes referred to in the liquid ejection tube and gas release tube may be any conduit or device allowing the transfer of oil and gas out of the interior of the conduit.

With reference to FIG. 1, the containment system 10 will now be explained. The conduit is eventually positioned over the plume 50 from a leaking wellhead, man-made structure, BOP 40 or where the leak emanates (e.g., seafloor). The conduit may be constructed in sections to provide a length allowing the conduit to span from the bottom of the ocean floor where the wellhead is located to at or near the water surface 22. In the preferred embodiment of the present invention, the conduit is first constructed and positioned laterally offset from the plume 50. Seawater is then pumped from the upper end of the conduit or containment tank to induce an upward flow of the seawater through the conduit. The conduit may then be moved laterally by drawing in or lengthening the cables as necessary, thereby enabling the conduit, at the opening 16 to be positioned directly over the plume 50. As gas and oil (hydrocarbons) escapes from the wellhead, the oil and gas travels up the conduit 12. The diameter B of the upper section 60 is preferably increased in one or more stages to accommodate gas expansion and hydrate dissociation. The conduit may be increased in diameter in more than one section. The liquid (i.e., oil and seawater) are pumped out of the conduit to a storage area, such as a tanker through the liquid ejection tube 30. Furthermore, the natural gas contained in the containment tank 20 may be released through the gas release tube 24 where the natural gas may be contained or flared. The liquid level 64 is then reduced below the water surface 22. Ambient water flows through the opening 16 into the interior 52 of the conduit 12. Alternatively, warm water and/or chemicals from the surface may be pumped anywhere within the interior 52 of the conduit. The warm water and/or chemicals provide the advantage of reducing the formation of hydrates. Additionally, the warm water may be used to prevent excessive cooling or freezing within the interior of the conduit. The escaping oil and gas emitted from the wellhead rise through the conduit where the oil and seawater (liquid) are pumped out the liquid ejection tube 30 and gas is released through the release tube respectively. Preferably, the flow of the oil and gas up through the conduit is maintained at a high velocity.

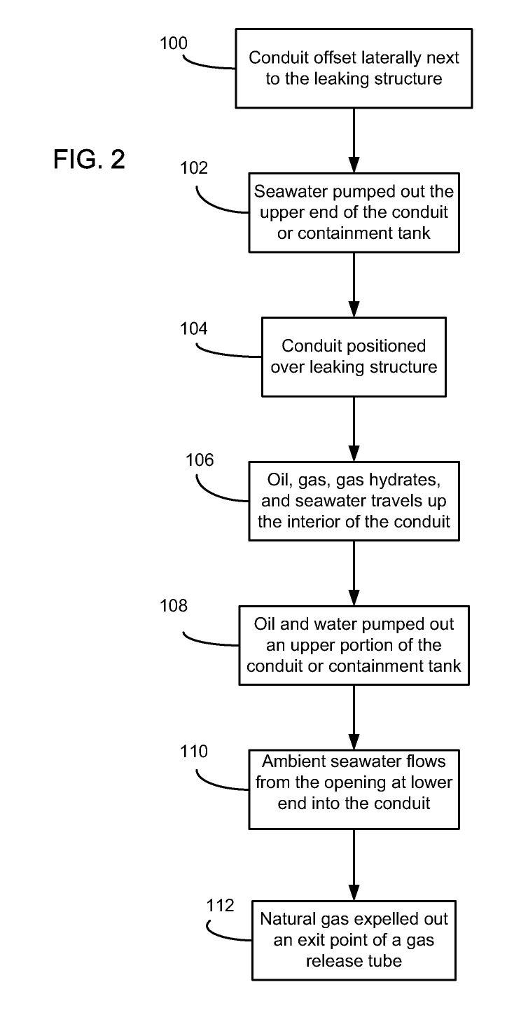

FIG. 2 is a flow chart illustrating the steps of containing and capturing oil and gas from a leaking structure, such as a BOP 40 according to the teachings of the present invention. With reference to FIGS. 1 and 2, the method will now be explained. The conduit may be constructed in sections to provide a length allowing the conduit to span from the bottom of the ocean floor where the wellhead is located to at or near the water surface 22. Prior to beginning the method, the conduit is assembled, preferably one section at a time and placed underwater. The method begins with step 100, where the conduit 12 is positioned laterally offset from the plume 50 of the leaking BOP 40 or other structure. The conduit is long enough to be positioned over the wellhead and still reach substantially near (relative to the depth of the water and length of the conduit) or at the water surface 22. The conduit may be constructed in sections to enable the conduit to span the length from the bottom of the ocean where the wellhead is located to at or near the water surface 22. In step 102, seawater is then pumped from the upper end of the conduit or containment tank to induce an upward flow of the seawater through the conduit. In step 104, the conduit, at the opening 16 is positioned over the plume 50 of the leaking man-made structure. In one embodiment, the conduit may be moved by lengthening or drawing in the cables 44 from the attachment station 46 to the base pylons 42. Next, in step 106, gas, oil, gas-hydrates and seawater escapes from the area of the leak and travels up the conduit 12 because of the pressure differential inducing an upward flow of fluids (i.e., seawater, oil, and gas). The diameter B of the upper section 60 may be increased in one or more stages to accommodate gas expansion and hydrate dissociation. The conduit may be increased in diameter in more than one section. In step 108, the liquid is pumped out of the conduit or containment tank to a storage area, such as a tanker through the liquid ejection tube 30. The liquid level 64 is then reduced below the water surface 22. Simultaneously, in step 110, ambient seawater flows through the lower end 14 through the opening 16 into the interior 52 of the conduit 12 and moves upwardly. Warm water may be used to prevent excessive cooling or freezing within the interior of the conduit. In step 112, the natural gas emitted from the wellhead escapes through the gas release tube 24 and aperture 26 where the gas may be contained or flared.

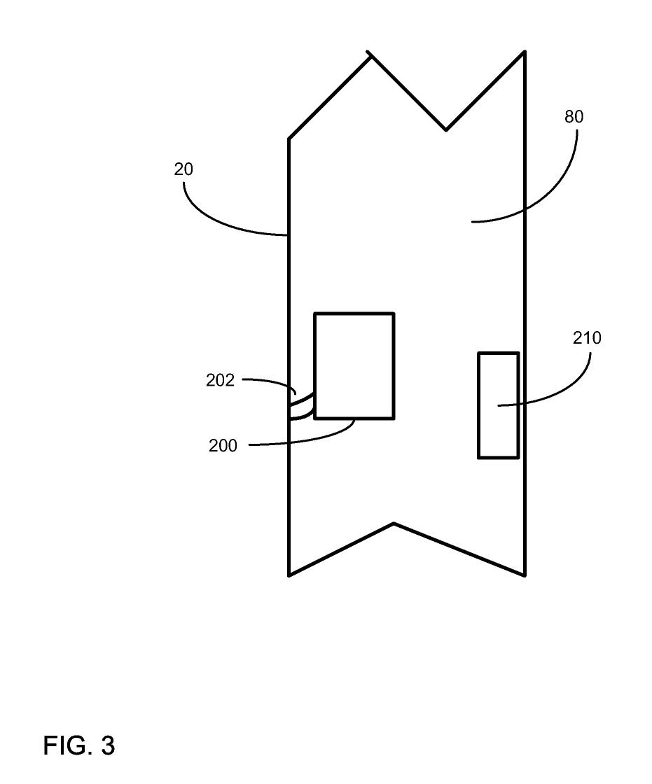

FIG. 3 is a side view of a heat exchanger 200 for use in the containment system 10 of FIG. 1. The heat exchange may be any device which is located in the interior of the main conduit or containment tank to add heat to liquids to melt gas-hydrates and prevent seawater from freezing. The heat exchanger may use liquid, electricity or any other heat source. In one embodiment, warm water may be injected through pipes 202 into the heat exchanger located within the interior 80 of the containment tank 20. The warm water increases the temperature of the liquid residing in the containment tank. Increased temperature of the liquid provides the advantage of melting or dissociating hydrates. Additionally, the warm water may be used to prevent excessive cooling or freezing within the interior of the conduit. The heat exchanger may be located anywhere within the interior of the conduit or containment tank and still remain in the scope of the present invention. In addition, instrumentation 210 may be located in the interior of the conduit or containment tank to measure temperature, pressure, fluid composition, hydrate formation and other physical or chemical properties. These measurements may be sent to an exterior control center, such as a computer located in a vessel located on the surface of the water.

The present invention utilizes a negative pressure differential which causes the water, oil and gas to flow upward away from the leaking structure. The oil and gas may be drawn from the interior of the conduit and stored in areas designated by the operators.

The present invention provides many advantages over existing containment systems. The present invention is a near source, non-contact system to a source or plume of a hydrocarbon leak underwater. In contact systems, a cap or other object is placed in direct contact with the BOP or other structure leaking hydrocarbons. This results in a rise in internal pressure which may result in leaks in other areas of the man-made leaking structure or other areas of the seafloor. The present invention, since the conduit does not contact the man-made structure, does not result in an increase in pressure within the well. In addition, the present invention is useable at greater underwater depths and does not suffer from clogging from gas-hydrates forming in the interior of the conduit. Furthermore, the present invention may overcome problems associated with gas expansion and hydrate dissociation as the oil and gas travels up to the water surface. The present invention provides a method and system which can effectively and economically capture and contain escaping oil and gas from a leaking man-made structure located at great underwater depths.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system of containing oil and gas leaking from an underwater man-made structure, the system comprising:
a conduit positioned over a plume leaking from the man-made structure;
the conduit having an upper end located at or substantially near the water surface and a lower end positioned over the leaking man-made structure, the lower end having an opening leading to an interior of the conduit;
means for creating a pressure differential between a pressure within the interior of the conduit and a pressure outside the conduit to induce an upward flow of fluids within the interior of the conduit, the interior pressure of the conduit being below the pressure outside the conduit;
means for expelling liquid from the interior of the conduit;
means for releasing gas from the interior of the conduit;
whereby liquid and gas flow upward from the leaking man-made structure through the interior of the conduit and are removed from the interior of the conduit.

2. The system according to claim 1 wherein the upper end of the conduit includes a containment tank.

3. The system according to claim 2 wherein the containment tank is located below the water surface.

4. The system according to claim 3 wherein the means for creating a pressure differential includes means for pumping any liquid located in the containment tank out of the containment tank.

5. The system according to claim 3 wherein the means for releasing gas is a gas release tube coupled to the containment tank.

6. The system according to claim 5 wherein the gas release tube releases gas above the water surface.

7. The system according to claim 6 wherein the gas release tube releases gas into a man-made structure.

8. The system according to claim 6 wherein the gas released by the gas release tube is flared.

9. The system according to claim 2 wherein the means for expelling liquid from the interior of the conduit includes:
a liquid ejection tube coupled to the containment tank for expelling the liquid from the interior of the conduit; and
a pump for pumping the liquid from the interior of the conduit.

10. The system according to claim 9 wherein the liquid ejection tube leads to a man-made structure located on the water surface for storing the expelled liquid.

11. The system according to claim 1 wherein the conduit includes an upper portion of the conduit having an increased diameter or series of increasing diameter relative to a lower portion of the conduit.

12. The system according to claim 1 wherein the conduit is constructed of two or more sections coupled together.

13. The system according to claim 1 wherein the lower end includes means for anchoring the conduit to a sea floor surface.

14. The system according to claim 13 wherein the means for anchoring the conduit includes a plurality of base pylons embedded in the sea floor surface.

15. The system according to claim 14 wherein the means for anchoring the conduit includes a plurality of attachment devices affixed to the base pylons and the conduit, the attachment devices having means for laterally and vertically moving the conduit.

16. The system according to claim 2 further comprising a heat exchanger located within the interior of the conduit or containment tank for heating liquid.

17. The system according to claim 1 wherein the lower end includes an induction bell for gathering leaking hydrocarbons from the man-made structure.

18. The system according to claim 17 wherein the induction bell includes a plurality of ports for injecting chemicals or warm water into the interior of the conduit.

19. A method of containing oil and gas leaking from an underwater man-made structure, the method comprising the steps of:
positioning a conduit over a plume leaking from the man-made structure, the conduit having an upper end located at or substantially near the water surface and a lower end having an opening leading to an interior of the conduit;
pumping liquid from an upper portion of the interior of the conduit to reduce an interior pressure of the conduit below a pressure outside the conduit to induce an upward flow of fluids within the interior of the conduit; and
expelling gas located within the interior of the conduit through a gas release tube coupled to an interior of the conduit.

20. The method according to claim 19 further comprising, prior to the step of positioning a conduit over the man-made structure, the steps of:
positioning the conduit offset laterally adjacent the plume of the man-made structure; and
pumping seawater from an upper portion of the interior of the conduit prior to the step of positioning the conduit over the man-made structure.

21. The method according to claim 19 wherein the upper portion of the conduit includes a containment tank and the step of pumping liquid from an upper portion includes pumping liquid located within the containment tank out of the conduit.

22. The method according to claim 19 wherein the step of expelling gas through a gas release tube includes expelling gas into a man-made structure.

23. The method according to claim 19 wherein the step of expelling gas through a gas release tube includes flaring gas above the water surface.

24. The method according to claim 19 wherein the step of pumping liquid from an upper portion of the conduit includes pumping the liquid to a man-made structure located on the water surface for storing the expelled liquid.

25. The method according to claim 19 further comprising the step of anchoring the conduit to a sea floor surface.

26. The method according to claim 19 further comprising utilizing a heat exchanger to heat liquid located in the interior of the conduit.

27. An apparatus for containing oil and gas leaking from an underwater man-made structure, the apparatus comprising:
a conduit having an upper end and a lower end with an opening, the conduit being sized for the lower end to be positioned over a plume leaking from the man-made structure and the upper end to be substantially near or at the water surface;
a containment tank located in the upper portion of the interior of the conduit;
a first tube for pumping liquid located within the containment tank out of the interior of the conduit, thereby creating a pressure differential between a pressure within the interior of the conduit and a pressure outside the conduit to induce an upward flow fluids within the interior of the conduit, the interior pressure of the conduit being below the pressure outside the conduit;
a second tube for releasing gas from the interior of the conduit;
whereby the conduit is positioned over the leaking man-made structure and liquid and gas flow upward from the leaking man-made structure through the interior of the conduit.

28. The apparatus according to claim 27 wherein the second tube releases gas into a man-made structure.

29. The apparatus according to claim 27 wherein the gas released by the second tube is flared.

30. The apparatus according to claim 27 wherein the first tube leads to a man-made structure located on the water surface for storing the expelled liquid.

31. The apparatus according to claim 27 wherein the lower end includes means for anchoring the conduit to a sea floor surface.

32. The apparatus according to claim 31 wherein the means for anchoring the conduit includes a plurality of cables affixed to a plurality of base pylons embedded in a sea floor and the conduit, the cables having means for laterally and vertically moving the conduit.

35. The apparatus according to claim 27 further comprising a heat exchanger located within the interior of the conduit or containment tank for heating liquid.
